(19) United States
(12) Patent Application Publication
(10) Pub. No.: US 2015/0244189 A1
(43) Pub. Date: Aug. 27, 2015

(54) BALANCER CIRCUIT AND BATTERY UNIT USING SAME

(71) Applicant: SHARP KABUSHIKI KAISHA, Osaka-shi, Osaka (JP)

(72) Inventor: Kensuke Baba, Osaka-shi (JP)

(73) Assignee: SHARP KABUSHIKI KAISHA, Osaka-shi, Osaka (JP)

(21) Appl. No.: 14/432,259

(22) PCT Filed: Sep. 10, 2013
(86) PCT No.: PCT/JP2013/074299

§ 371 Date: Mar. 30, 2015

(30) Foreign Application Priority Data
Oct. 24, 2012 (JP) 2012-234371

(51) Int. Cl. H02J 7/00

(52) U.S. Cl. CPC H02J 7/0014; H02J 7/0052

(57) ABSTRACT

A balancer circuit connected to a battery pack having a plurality of secondary cells connected in series, and comprising: a capacitance element; and a switching unit that switches the connection state for both ends of the capacitance element between a state in which same are connected to both ends of one of the secondary cells and a state in which same are connected to both ends of another secondary cell. The balancer circuit corrects the balance between the voltages for the plurality of secondary cells by executing a switching operation that repeats said switching, and comprises a detection unit that detects said state of balance by detecting the size of the overshoot component in a voltage waveform at sites connected to the capacitance element.

### TECHNICAL FIELD

The present invention relates to a balancer circuit that corrects a balance state among secondary batteries and to a battery unit that uses the balancer circuit.

### BACKGROUND ART

In recent years, a large electricity accumulation system using a storage battery is under development. The development of a large electricity accumulation system is performed aiming at, for example, a peak shift due to tight electric power of today, a device as an urgent backup power source, or stable use of unstable environmental energy such as photovoltaic power generation and the like.

As a battery used in such kind of electricity accumulation system, a lead accumulator is conventionally used. However, in recent years, a lithium ion battery advantageous to a small size, a small volume and a light weight is popularly adopted.

In an electricity accumulation system using a lithium ion battery, there are many cases where it is difficult to secure a large capacitance by means of one single battery (secondary battery) for reasons of production and safety. Because of this, generally, a battery pack is configured by using a plurality of single batteries in which intermediate-sized single batteries of about 10 Ah to 20 Ah are combined in series or in parallel, and this battery pack is used in the electricity accumulation system.

On the other hand, if a plurality of lithium ion batteries are used, some characteristic unevenness occurs inevitably among the single batteries. Because of this, there is a case where a balancer circuit is used aiming at correcting voltage and capacitance differences among the single batteries. FIG. 5 shows a configuration example of a battery unit in which such a balancer circuit is disposed.

A battery unit 101 shown in FIG. 5 includes: a battery pack 102 in which single batteries (121 to 123) are connected in series; and a balancer circuit 103 that corrects a balance state (voltage balance state) among the single batteries. Besides, the balancer circuit 103 has an oscillator 131, a switch portion 132, and capacitance elements (133a, 133b).

The switch portion 132 is configured to switch a connection state of both ends of the capacitance element 133a between states that include: a state where both ends of the capacitance element 133a are connected to both ends of the single battery 123; and a state where both ends of the capacitance element 133a are connected to both ends of the single battery 122. Besides, the switch portion 132 is configured to switch a connection state of both ends of the capacitance element 133b between states that include: a state where both ends of the capacitance element 133b are connected to both ends of the single battery 122; and a state where both ends of the capacitance element 133b are connected to both ends of the single battery 121.

The balancer circuit 103 executes a switching operation that performs repeatedly the above switchover. According to this switching operation, electric charges are moved via the capacitance elements (133a, 133b) such that voltage unevenness among the single batteries (121 to 123) becomes small, so that the balance state among the single batteries is corrected.

### CITATION LIST

### Patent Literature

### PLT1: JP-A-2010-166800

### SUMMARY OF INVENTION

### Technical Problem

Power consumption of the above balancer circuit increases as the number of operations increases (especially, as the period of the switching operation becomes shorter). If the power consumption of the balancer circuit becomes larger, self-discharge of the battery unit is accelerated all the more, whereby a disadvantage occurs, in which the function as a storage battery deteriorates.

To curb such disadvantage to a minimum level, it is conceivable to control the switching operation in accordance with the balance state among the single batteries. As an example, it is conceivable that when the balance state among the single batteries is relatively good (when necessity for correcting the balance state is small), the switching operation is stopped or performed at a long period (i.e., slowly) to curb the power consumption of the balancer circuit.

Form such situation, it is desirable that the balancer circuit has a function to detect the balance state among the single batteries. In light of the above problems, it is an object of the present invention to provide a balancer circuit that is able to not only correct a balance state among secondary batteries by executing a switching operation but also detect the balance state and provide a battery unit that uses the balancer circuit.

### Solution to Problem

A balancer circuit according to the present invention has a configuration which the balancer circuit is connected to a battery pack in which a plurality of secondary batteries are connected in series, the balancer circuit comprises: a capacitance element, and a switching portion that performs a switchover of a connection state of both ends of the capacitance element between states which include: a state where both ends of the capacitance element are connected to both ends of any one of the secondary batteries; and a state where both ends of the capacitance element are connected to both ends of another one of the secondary batteries, wherein the balancer circuit corrects a voltage balance state among the plurality of secondary batteries by executing a switching operation that performs repeatedly the switchover, and the balancer circuit includes a detection portion that detects the balance state by detecting a size of an overshoot component of a voltage waveform at a point connected to the capacitance element.

According to the present configuration, it becomes possible to not only correct a balance state (degree of good or bad balance) among the secondary batteries by executing the switching operation but also detect the balance state.

Besides, in the above structure, more specifically, a configuration may be employed, in which the capacitance element is a part that has a lead wire connected to an electrode of the capacitance element, and the detection portion includes: a ferrite beads core through which the lead wire passes, a power line which passes through the ferrite beads core together with the lead wire, and detects the balance state based on a voltage signal output from the power line.

Besides, in the above structure, more specifically, a configuration may be employed, in which the switching operation is controlled based on a detection result of the balance state. Besides, in the above structure, more specifically, a configuration may be employed, in which a period of the switching operation is adjusted based the detection result of the balance state.

A battery unit according to the present invention has a configuration which comprises: a battery pack in which a plurality of secondary batteries are connected in series, and the balancer circuit having the above configuration that corrects a voltage balance state among the plurality of secondary batteries. According to the present configuration, it becomes possible to enjoy an advantage of the balancer circuit having the above configuration.

### Advantageous Effects of Invention

According to the balancer circuit of the present invention, it becomes possible to not only correct the balance state among the secondary batteries by executing the switching operation but also detect the balance state. Besides, according to the battery unit of the present invention, it becomes possible to enjoy an advantage of the balancer circuit according to the present invention.

### BRIEF DESCRIPTION OF DRAWINGS

FIG. 1 is a configurative view of a battery unit according to an embodiment.

FIG. 2 is a descriptive view relevant to a mounting form of a portion of a balancer circuit according to an embodiment.

FIG. 3 is a graph showing a voltage waveform at a fixed point TP1.

FIG. 4 is a descriptive view relevant to detection of a size of an overshoot component.

FIG. 5 is a configurative view of a battery unit according to a conventional example.

### DESCRIPTION OF EMBODIMENTS

An embodiment of the present invention is described with reference to each drawing.

### [Configuration of Battery Unit]

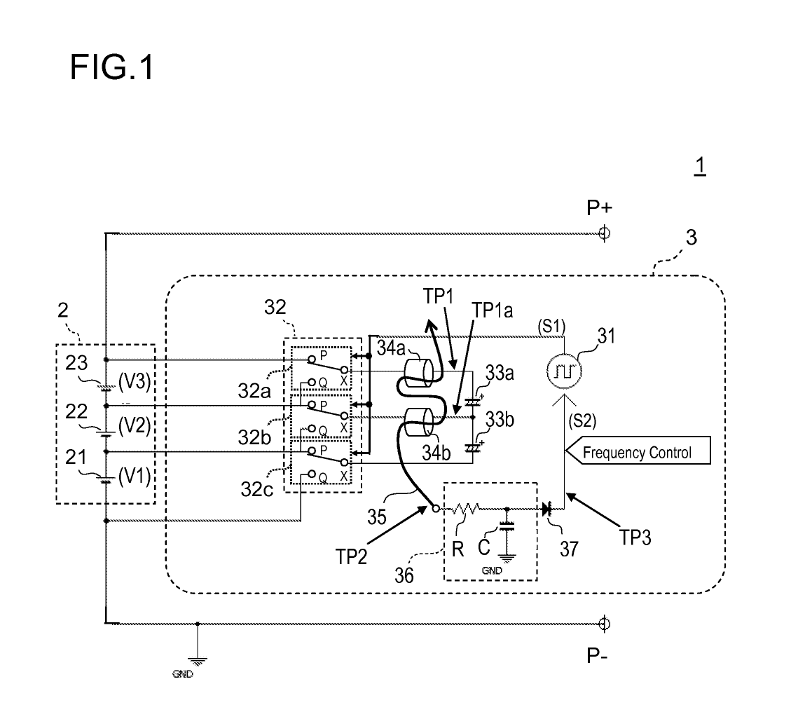

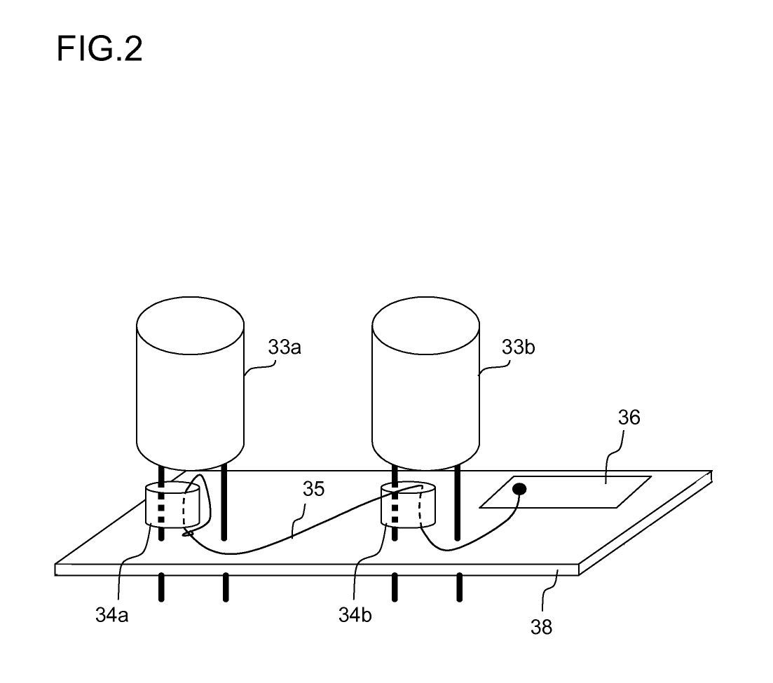

FIG. 1 is a configuration view of a battery unit 1 according to the present embodiment. As shown in this figure, the battery unit 1 includes a battery pack (battery pack module) 2, and a balancer circuit 3. Besides, FIG. 2 schematically shows a mounting form of a portion of the balancer circuit 3.

The battery pack 2 has a form in which a plurality of single batteries (21 to 23) are connected in series, and is connected to a d.c. power source circuit (not shown) that performs charge and discharge of the battery pack 2. More specifically, a positive electrode of the single battery 21 is connected to a negative electrode of the single battery 22, and a positive electrode of the single battery 22 is connected to a negative electrode of the single battery 23. And, a negative electrode of the single battery 21 is connected to a negative electrode P− (connected to a ground potential) of the above d.c. power source circuit, and a positive electrode of the single battery 23 is connected to a positive electrode P+ of the above d.c. power source circuit.

Each single battery (21 to 23) is a secondary battery (e.g., lithium ion battery) that is able to be repeatedly charged and discharged. The battery pack 2 may be disposed in the battery unit 1 in a fixed manner or may be disposed removably.

The balancer circuit 3 has an oscillator 31, a switch portion 32, capacitance elements (33a, 33b), ferrite beads cores (34a, 34b), a power line 35, an integration circuit 36, a diode 37, a mounting board 38 and the like.

The oscillator 31 continuously outputs a pulse signal S1 (signal in which a H level and a L level appear alternately) to the switch portion 32. Besides, the oscillator 31 changes frequency of the pulse signal S1 in accordance with a control signal S2 input from the integration circuit 36. It becomes apparent from later description how the frequency of the pulse signal S1 is changed.

The switch portion 32 has switches (32a to 32c). Besides, each switch (32a to 32c) is configured by using, for example, a FET device, and has terminals of a terminal P, a terminal Q, and a terminal X.

And, each switch (32a to 32c) is configured to be able to be switched among states of: a P-X connection state Sp (state where the terminal X is connected to the terminal P and the terminal Q is connected to no terminal); a Q-X connection state Sq (state where the terminal X is connected to the terminal Q and the terminal P is connected to no terminal); and a non-connection state Sn (state where all the terminals are connected to no terminal).

In the meantime, the terminal P of the switch 32a is connected to the positive electrode of the single battery 23. Besides, the terminal Q of the switch 32a and the terminal P of the switch 32b are connected to the negative electrode of the single battery 23 and the positive electrode of the single battery 22. Besides, the terminal Q of the switch 32b and the terminal P of the switch 32c are connected to the negative electrode of the single battery 22 and the positive electrode of the single battery 21. Besides, the terminal Q of the switch 32c is connected to the negative electrode of the single battery 21.

Each capacitance element (33a, 33b) is an element having a predetermined electric capacitance and is an electrolytic capacitor, for example. Besides, each capacitance element (33a, 33b) is a part having a form in which two lead wires (terminal leg portion) extend from a main body portion which incorporates both electrodes. These lead wires include a lead wire connected to one electrode and a lead wire connected to the other electrode. The two lead wires are mounted on the mounting board 38, whereby each capacitance element (33a, 33b) forms a portion of the balancer circuit 3.

In the meantime, one end (one electrode) of the capacitance element 33a is connected to the terminal X of the switch 32a. Besides, the other end (other electrode) of the capacitance element 33a is connected to the terminal X of the switch 32b and one end (one electrode) of the capacitance element 33b. Besides, the other end (other electrode) of the capacitance element 33b is connected to the terminal X of the switch 32c.

As shown in FIG. 2, one (lead wire connected to the terminal X of the switch 32a) of the lead wires of the capacitance element 33a passes through the ferrite beads core 34a. The ferrite beads core 34a is in a state of being interposed between the main body portion of the capacitance element 33a and the mounting board 38.

Besides, as shown in FIG. 2, one (lead wire connected to the terminal X of the switch 32b) of the lead wires of the capacitance element 33b passes through the ferrite beads core 34b. The ferrite beads core 34b is in a state of being interposed between the main body portion of the capacitance element 33b and the mounting board 38.

The power line 35 is a UEW line, for example, and as shown in FIG. 2, passed successively through the ferrite beads core 34a and the ferrite beads core 34b, and its tip end is connected and fixed to the integration circuit 36. The other tip end of the power line 35 U-turns and is tied to the power line 35 itself not to come out of the ferrite beads core 34a.

In the meantime, the power line 35 is highly flexible, and it is an easy work to pass the power line 35 through each ferrite beads core (34a, 34b). In this way, the one lead wire of the capacitance element 33a is inserted into the ferrite beads core 34a, and the power line 35 is extended along the lead wire. Besides, the one lead wire of the capacitance element 33b is inserted into the ferrite beads core 34b, and the power line 35 is extended along the lead wire.

The integration circuit 36 is a circuit disposed on the mounting board 38, and has a resistance element R and a capacitance element C. The power line 35 is connected to one end of the resistance element R, and the other end of the resistance element R is grounded via the capacitance element C and connected to an anode of the diode 37. Besides, a cathode of the diode 37 is connected to the oscillator 31. In this way, the integration circuit 36 functions to integrate a voltage signal input from the power line 35 and output a voltage signal, corresponding to the integration result, to the oscillator 31 via the diode 37.

The battery unit 1 having the above configuration operates to charge the battery pack 2 by using electric power received from the above d.c. power source circuit and to supply electric power, discharged from the battery pack 2, to the d.c. power source circuit. And, the balance circuit 3 operates to correct a voltage balance state (degree of good or bad balance, and there is a case where it is called a “balance state among the single batteries”) among the single batteries (21 to 23).

### [Operation of Balance Circuit]

Next, operation of the balance circuit 3 is described in more detail. The switch portion 32 executes a switching operation that repeats a series of steps A to D operations described below.

The step A operation is an operation that switches the state of each switch (32a to 32c) to a non-connection state Sn. During a time when the step A operation is performed and each switch (32a to 32c) is in the non-connection state Sn, charge and discharge of each capacitance element (33a, 33b) are not performed and each capacitance element (33a, 33b) is kept in a state of being charged with an amount of electric charges.

The step B operation is an operation that is performed after the step A operation and switches the state of each switch (32a to 32c) to the P-X connection state Sp. During a time when the step B operation is performed and each switch (32a to 32c) is in the P-X connection state Sp, input and output of electric charges (seeming movement of electric charges via the capacitance element) to and from each capacitance element (33a, 33b) are performed in accordance with a voltage of the single battery in the battery pack 2.

More specifically, the input and output of electric charges to and from the capacitance element 33a are performed such that a voltage V3 of the single battery 23 and a voltage between both electrodes of the capacitance element 33a balance with each other. Besides, the input and output of electric charges to and from the capacitance element 33b are performed such that a voltage V2 of the single battery 22 and a voltage between both electrodes of the capacitance element 33b balance with each other.

The step C operation is an operation that is performed after the step B operation and switches the state of each switch (32a to 32c) to the non-connection state Sn. During a time when the step C operation is performed and each switch (32a to 32c) is in the non-connection state Sn, the charge and discharge of each capacitance element (33a, 33b) are not performed and each capacitance element (33a, 33b) is kept in a state of being charged with an amount of electric charges.

The step D operation is an operation that switches the state of each switch (32a to 32c) to the Q-X connection state Sq. During a time when the step D operation is performed and each switch (32a to 32c) is in the Q-X connection state Sq, the input and output of electric charges (seeming movement of electric charges via the capacitance element) to and from each capacitance element (33a, 33b) are performed in accordance with the voltage of the single battery in the battery pack 2.

More specifically, the input and output of electric charges to and from the capacitance element 33a are performed such that the voltage V2 of the single battery 22 and the voltage between both electrodes of the capacitance element 33a balance with each other. Besides, the input and output of electric charges to and from the capacitance element 33b are performed such that a voltage V1 of the single battery 21 and the voltage between both electrodes of the capacitance element 33b balance with each other. After the step D operation, the step A operation is performed.

In the meantime, the steps A to D operations are successively performed in synchronization with (e.g., whenever a H-level pulse arrives) a pulse signal S1 received from the oscillator 31. The above switching operation is performed, whereby the balance state among the single batteries is corrected.

Besides, under the situation where the above switching operation is performed, voltage waveforms at the one end (fixed point TP1 shown in FIG. 1) of the capacitance element 33a and the one end (fixed point TP1a shown in FIG. 1) of the capacitance element 33b contain an overshoot component in accordance with the balance state among the single batteries. In the meantime, it can be said that the fixed point TP1 is an example of a point connected to the capacitance element 33a, and the fixed point TP1a is an example of a point connected to the capacitance element 33b.

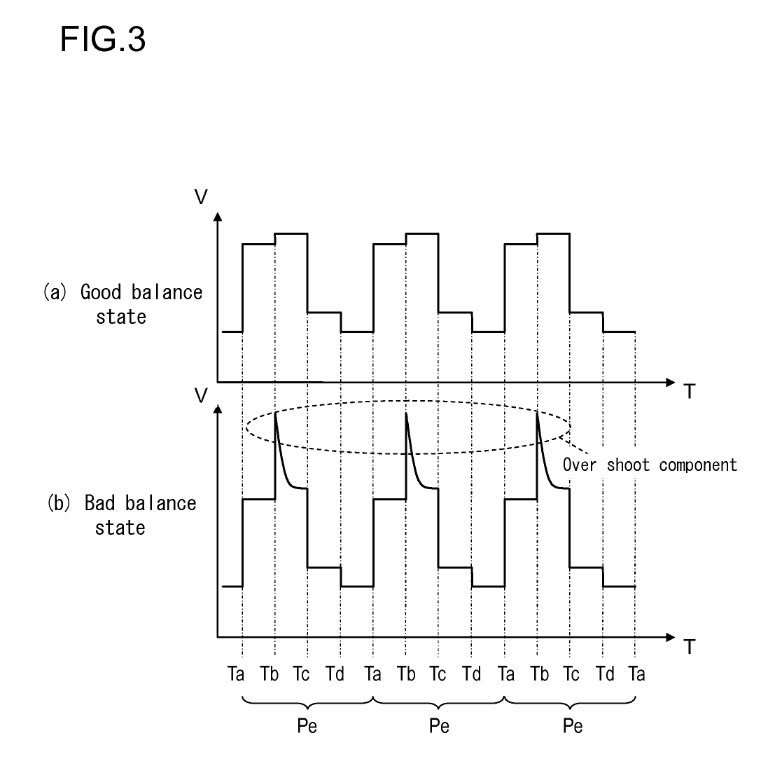

FIG. 3 shows a voltage waveform at the fixed point TP1 as an example under the situation where the above switching operation is performed. FIG. 3 shows: (a) a voltage waveform in a case where the balance state among the single batteries is good; and (b) a voltage waveform in a case where the balance state among the single batteries is bad. In the meantime, a voltage waveform at the fixed point TP1a is not shown, but it is basically similar to the waveforms shown in FIG. 3.

In FIG. 3, a timing Ta shows a timing when the step A operation is performed, a timing Tb shows a timing when the step B operation is performed, a timing Tc shows a timing when the step C operation is performed, and a timing Td shows a timing when the step D operation is performed. As shown in FIG. 3, the switching operation is an operation that repeats the series of steps A to D operations at a period Pe.

Besides, in the case where the balance state among the single batteries is bad, namely, in a case where the voltage unevenness among the single batteries (21 to 23) is large, as shown in FIG. 3 (b), the overshoot component of the voltage waveform at the fixed point TP1 (or fixed point TP1a) becomes large. In the meantime, the overshoot component shown in the example of FIG. 3 occurs when the step B operation is performed. On the other hand, in the case where the balance state among the single batteries is good, namely, in a case where the voltage unevenness among the single batteries (21 to 23) is relatively small, as shown in FIG. 3 (a), such overshoot component becomes very small.

As described above, the size of the overshoot component (ringing component) of the voltage waveform at the fixed point TP1 (or fixed point TP1a) becomes larger as the balance state among the single batteries becomes worse. The balancer circuit 3 has a function the uses this phenomenon to detect the balance state among the single batteries. In other words, the balancer circuit 3 has a function that detects the size of the overshoot component of the voltage waveform at the fixed point TP1 (or fixed point TP1a) as an index of the balance state among the single batteries.

The above function is achieved mainly by the ferrite beads cores (34a, 34b), the power line 35, and the integration circuit 36. In other words, the ferrite beads core 34a generates electromagnetic induction in accordance with the overshoot component of the voltage waveform at the fixed point TP1 to guide spatially the overshoot component to the power line 35. Besides, the ferrite beads core 34b generates electromagnetic induction in accordance with the overshoot component of the voltage waveform at the fixed point TP1a to guide spatially the overshoot component to the power line 35.

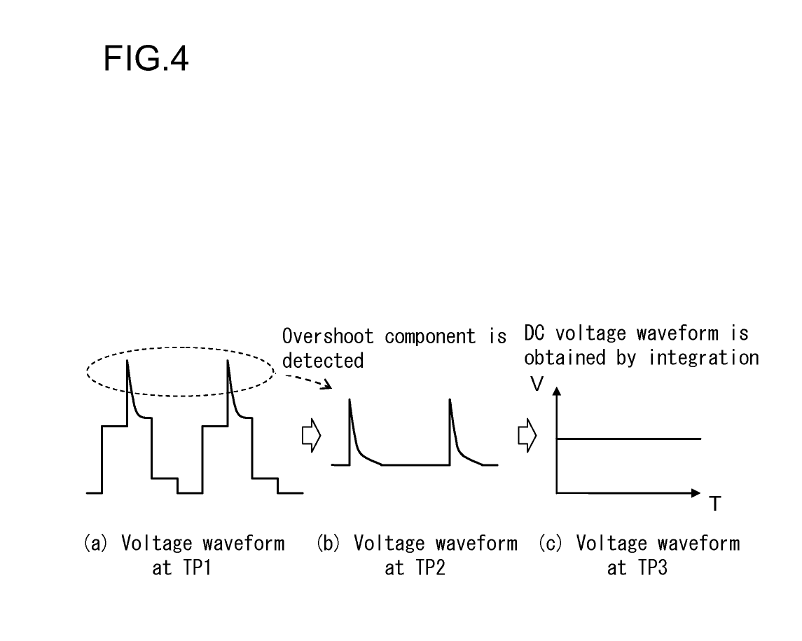

In this way, the overshoot component of the voltage waveform at the fixed point TP1 (or fixed point TP1a) is detected. In other words, when the voltage waveform at the fixed point TP1 (or fixed point TP1a) is in a state shown in FIG. 4 (a), a voltage waveform (voltage waveform at a fixed point TP2 shown in FIG. 1) at the power line 35 becomes a voltage waveform that represents the detection result as shown in FIG. 4 (b).

If a signal of such voltage waveform is input into the integration circuit 36, the integration circuit 36 outputs a voltage signal obtained by integrating the signal. In other words, the voltage waveform (voltage waveform at a fixed point TP3 shown in FIG. 1) output from the integration circuit 36 becomes a voltage waveform of a DC voltage obtained by the integration as shown in an example in FIG. 4 (c).

A size of the DC voltage reflects the size of the overshoot component of the voltage waveform at the fixed point TP1 (or fixed point TP1a). In other words, the smaller the overshoot component is (the better the balance state among the single batteries is), the smaller the DC voltage becomes, and the larger the overshoot component is (the worse the balance state among the single batteries is), the larger the DC voltage becomes. The balancer circuit 3 is able to easily detect the balance state among the single batteries by obtaining the voltage waveform of the DC voltage.

Besides, a signal of the voltage waveform at the fixed point TP3 is input as the control signal S2 into the oscillator 31. And, the oscillator 31 changes the frequency of the pulse signal S1 in accordance with a voltage value of the control signal S2. More specifically, the higher the voltage value of the control signal S2 becomes (i.e., the better the balance state among the single batteries is), the lower the frequency of the pulse signal S1 is made, and the lower the voltage value of the control signal S2 becomes (i.e., the worse the balance state among the single batteries is), the higher the frequency of the pulse signal S1 is made.

A specific form of changing the frequency is not limited. For example, the frequency of the pulse signal S1 may be changed in accordance with whether the voltage value of the control signal S2 is higher than a predetermined threshold value or not, or may be changed in an analog manner in accordance with the voltage value of the control signal S2.

In the meantime, the higher the frequency of the pulse signal S1 becomes, the shorter the period Pe of the switching operation performed by the switch portion 32 becomes (the operation frequency becomes higher). Because of this, the correction of the balance state among the single batteries is performed more frequently, and it becomes possible to improve the balance state quickly and sufficiently all the more. On the other hands, the lower the frequency of the pulse signal S1 becomes, the longer the period Pe of the switching operation performed by the switch portion 32 becomes. Because of this, the correction frequency becomes low, but it becomes possible to curb power consumption and the like required for the switching operation all the more.

As described above, the balancer circuit 3 changes the frequency of the pulse signal S1 and adjusts the period Pe of the switching operation, thereby efficiently executing the correction of the balance state among the single batteries.

In other words, when the balance state among the single batteries is relatively bad, the balancer circuit 3 shortens the period Pe of the switching operation, and improves the balance state quickly and sufficiently. On the other hand, when the balance state among the single batteries is relatively good, the balancer circuit 3 prolongs the period Pe of the switching operation, and curbs the power consumption and the like required for the switching operation.

Besides, even when the balance state among the single batteries is good, the balancer circuit 3 only prolongs the period Pe of the switching operation as described above, but does not stop the switching operation. Because of this, a device is not necessary for resuming the switching operation when the balance state among the single batteries becomes bad.

In other words, a case can occur, where even if the balance state among the single batteries becomes good temporarily, the balance state among the single batteries becomes bad because of unevenness in charge and discharge waveforms and the like when performing the charge and discharge. If the specifications are designed to stop the switching operation when the balance state among the single batteries is good, to suitably keep the balance state among the single batteries in any case, an additional device becomes necessary for resuming the switching operation when the balance state among the single batteries becomes bad. In the meantime, as the device, there are a device for detecting the charge start, the discharge start and the like, and a device for starting the switching operation in accordance with the detection result and the like.

In this point, according to the balancer circuit 3 of the present embodiment, even when the balance state among the single batteries is good, the switching operation continues, and when the balance state among the single batteries becomes bad, the voltage value of the control signal S2 becomes high automatically. By using this phenomenon, the balancer circuit 3 is able to automatically shorten the period Pe of the switching operation; accordingly, another external control trigger signal and the like are not required, but it is possible to activate the operation for correcting the balance state among the single batteries.

### [Others]

As described above, the balancer circuit 3 according to the present embodiment is connected to the battery pack 2 in which the plurality of single batteries (21 to 23) are connected in series, and includes the capacitance elements (33a, 33b) and the switch portion 32. In the meantime, the switch portion 32 switches the connection state of both ends of the capacitance element 33a between the states that include: the state where both ends of the capacitance element 33a are connected to both ends of the single battery 23; and the state where both ends of the capacitance element 33a are connected to both ends of the single battery 22, and switches the connection state of both ends of the capacitance element 33b between the states that include: the state where both ends of the capacitance element 33b are connected to both ends of the single battery 22; and the state where both ends of the capacitance element 33b are connected to both ends of the single battery 21. The balancer circuit 3 executes the switching operation that repeatedly performs such switchover, thereby correcting the balance state among the single batteries.

And further, the balancer circuit 3 includes the function portion (detection portion) that detects the size of the overshoot component of the voltage waveform at the fixed point TP1 (or fixed point TP1a connected to the capacitance element 33b) connected to the capacitance element 33a, thereby detecting the balance state among the single batteries. Because of this, according to the balancer circuit 3, it is possible to not only correct the balance state among the single batteries by executing the switching operation but also detect the balance state.

Besides, the balancer circuit 3 controls the switching operation based on the detection result of the balance state among the single batteries. More specifically, the balancer circuit 3 adjusts the period of the switching operation based on the detection result of the balance state among the single batteries. In this way, the balancer circuit 3 efficiently executes the correction of the balance state among the single batteries. In the meantime, the detection result of the balance state among the single batteries may be used for other various kinds of uses.

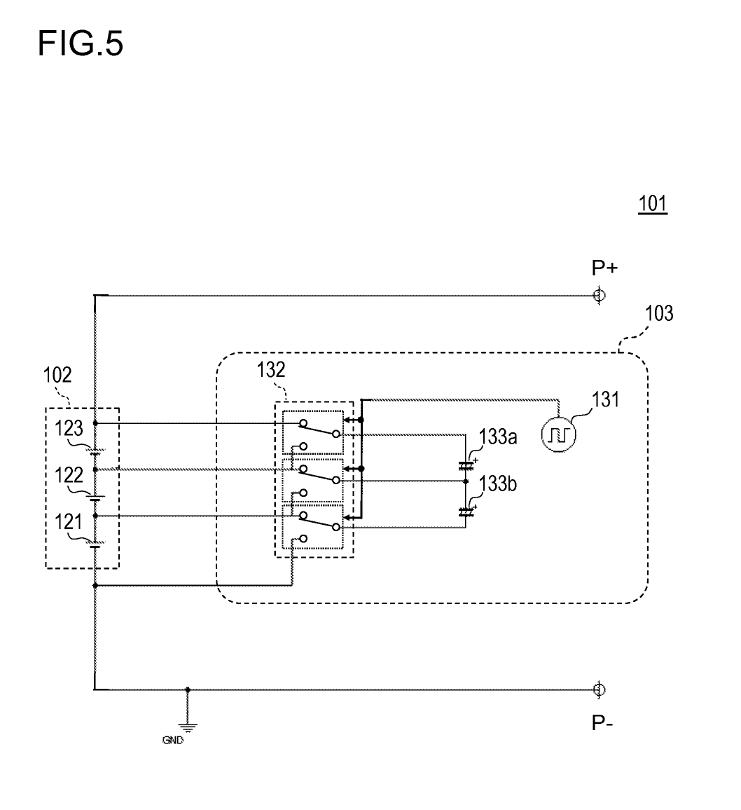

Besides, the configuration (see FIG. 1) of the balancer circuit 3 according to the present embodiment is achievable by performing a relatively small number of modifications on the basis of the configuration (see FIG. 5) of the conventional balancer circuit. Because of this, it is relatively easy to modify such conventional balancer circuit to achieve the configuration of the present embodiment, and in this way, it becomes possible to obtain the same effects as the present embodiment.

In the meantime, the balancer circuit 3 according to the present embodiment corresponds to the battery pack in which the three single batteries are connected in series as an example. However, the balancer circuit 3 may correspond to a battery pack in which two single batteries (secondary batteries) are connected in series, or may correspond to a battery pack in which four or more single batteries (secondary batteries) are connected in series. The balancer circuit 3 can correspond to any case by suitably setting the configuration of the switch portion 32 and the number of capacitance elements and ferrite beads cores and the like in accordance with the number of single batteries (secondary batteries) of the battery pack.

Besides, the switching operation in the present embodiment is the operation that repeats the series of steps A to D operations. However, another form may be used as long as it does not depart from the spirit. As an example, the switching operation may be an operation which does not perform the above steps A and C operations but alternately performs the steps B and D operations.

Besides, the configuration of the present invention is able to be modified, besides the above embodiment, in a range without departing from the spirit of the invention. In other words, it should be considered that the above embodiment is an example in all respects and is not limiting. It should be understood that the technical scope of the present invention is not indicated by the above description of the embodiment but by the claims, and all modifications within the scope of the claims and the meaning equivalent to the claims are covered.

### INDUSTRIAL APPLICABILITY

The present invention is applicable to battery units and the like.

### REFERENCE SIGNS LIST

1 battery unit
2 battery pack
21 to 23 single batteries (secondary batteries)
3 balancer circuit
31 oscillator
32 switch portion
32a to 32c switches
33a, 33b capacitance elements
34a, 34b ferrite beads cores
35 power line
36 integration circuit
37 diode
38 mounting board
C capacitance element
R resistance element

1. A balancer circuit connected to a battery pack in which a plurality of secondary batteries are connected in series, comprising:
a capacitance element, and
a switching portion that performs a switchover of a connection state of both ends of the capacitance element between states which include: a state where both ends of the capacitance element are connected to both ends of any one of the secondary batteries; and a state where both ends of the capacitance element are connected to both ends of another one of the secondary batteries,
wherein the balancer circuit corrects a voltage balance state among the plurality of secondary batteries by executing a switching operation that performs repeatedly the switchover, and
the balancer circuit includes a detection portion that detects the balance state by detecting a size of an overshoot component of a voltage waveform at a point connected to the capacitance element.

2. The balancer circuit according to claim 1, wherein
the capacitance element is a part that has a lead wire connected to an electrode of the capacitance element, and
the detection portion includes:
a ferrite beads core through which the lead wire passes,
a power line which passes through the ferrite beads core together with the lead wire, and
detects the balance state based on a voltage signal output from the power line.

3. The balancer circuit according to claim 2, wherein
the switching operation is controlled based on a detection result of the balance state.

4. The balancer circuit according to claim 3, wherein
a period of the switching operation is adjusted based the detection result of the balance state.

5. A battery unit comprising:
a battery pack in which a plurality of secondary batteries are connected in series, and
a balancer circuit according to claim 1 that corrects a voltage balance state among the plurality of secondary batteries.

6. A battery unit comprising:
a battery pack in which a plurality of secondary batteries are connected in series, and
a balancer circuit according to claim 2 that corrects a voltage balance state among the plurality of secondary batteries.

7. A battery unit comprising:
a battery pack in which a plurality of secondary batteries are connected in series, and
a balancer circuit according to claim 3 that corrects a voltage balance state among the plurality of secondary batteries.

8. A battery unit comprising:
a battery pack in which a plurality of secondary batteries are connected in series, and
a balancer circuit according to claim 4 that corrects a voltage balance state among the plurality of secondary batteries.
